(19) United States
(12) Patent Application Publication
(10) Pub. No.: US 2012/0114939 A1
(43) Pub. Date: May 10, 2012

(54) Ceramic Component and Fabrication Method

(75) Inventors: Matthew Paul Hills, Cambridge (GB); Mark Anthony Steele Henson, Stafford (GB)

(73) Assignee: Environmental Monitoring and Control Limited, Stafford (GB)

(21) Appl. No.: 12/089,866

(22) PCT Filed: Oct. 11, 2006
(86) PCT No.: PCT/GB2006/003779

§ 371 Date: Oct. 6, 2008

(30) Foreign Application Priority Data
Oct. 12, 2005 (GB) 0520778.2

(51) Int. Cl. D02G 3/16; B32B 18/00; D02G 3/36; B32B 37/06; B32B 38/04

(52) U.S. Cl. 428/367; 156/85; 156/86; 428/392; 428/394

(57) ABSTRACT

The subject invention pertains to a method for fabricating a ceramic component by encircling a core with an unsintered or partially-sintered ceramic sheath and sintering the sheath such that it shrinks towards or into contact with the core. In preferred embodiments the core may be electrically-conducting or heat conducting and surrounded by an insulating ceramic sheath. The subject invention also concerns a ceramic component.

The invention relates to a ceramic component and to a method for fabricating ceramic components. In this context, the term ceramic component refers to a component fabricated at least in part from a ceramic material.

The invention provides a method for fabricating a ceramic component, and a ceramic component, as defined in the appended independent claims, to which reference should now be made. Preferred or advantageous features of the invention are defined in dependent subclaims.

In a preferred embodiment, the invention thus provides a method for fabricating a component formed, at least in part, from a ceramic material. The method comprises the steps of providing a core comprising a material such as a sintered ceramic material or a metallic material. The core is then encircled with an unsintered or partially-sintered ceramic sheath or sleeve, and the ceramic sheath fired, or sintered, such that it shrinks towards or into contact with the core. Advantageously, the unsintered or partially-sintered ceramic sheath is a sufficiently close fit around the core that the shrinkage of the ceramic sheath during sintering causes it to shrink onto the core.

Embodiments of the invention may be used to fabricate ceramic components in which an electrically-conducting or heat-conducting core is encircled or surrounded by an insulating ceramic. An example of such a component is a SiC rod surrounded by a SiAION sheath, which may be used in the fabrication of probes for measuring hydrogen concentration in molten metals. In this example the electrically-conductive SiC rod is surrounded by a SiAION sheath that electrically insulates and chemically protects the SiC from the molten metal, and mechanically supports the SiC.

A further embodiment of the invention may be used to fabricate ceramic components for use in fuel cells. An example of such a component comprises a porous core of partially-sintered MMA (magnesia/magnesium aluminate), or an MMA core which is fully sintered and still porous, on the surface of which are formed the anodes and cathodes of the fuel cell, separated by electrolyte layers of YSZ (yttrium-stabilised zirconia). Gaseous fuel, such as hydrogen, may then be fed into the fuel cell through the porous MMA. In this example the electrolyte layers may advantageously be formed as extruded sheaths which are sintered onto the core.

In a preferred embodiment, the method may achieve an effective seal, such as an hermetic seal, between the core and the surrounding ceramic. This results from the shrinkage of the sheath onto the core during sintering. The degree of sealing may be predetermined by controlling the closeness of the fit between the core and the unsintered or partially-sintered ceramic sheath, and the degree of shrinkage of the sheath during sintering. The choice of materials for the core and the sheath may also affect the sealing; for example, if the core and the sheath share a common material that melts, or undergoes rapid diffusion, during sintering, then a bond may form between the core and the sheath during sintering.

In some applications it may not be desired to achieve a bond or seal between the core and the sheath, but to produce a fit that provides controlled porosity between the core and the sheath. This may advantageously be achieved through control of the relative dimensions of the core and the sheath and control of the sintering and shrinkage of the sheath.

It may be noted that as the ceramic sheath shrinks during sintering, and if the core does not shrink or shrinks to a lesser extent, then circumferential tensile stresses may be set up in the sheath. If the sheath is of insufficient thickness, it may then crack. The thickness of the sheath is preferably sufficient to avoid substantial cracking, taking into account the relative shrinkage of the sheath and the core during sintering and their initial dimensions. For example, if a sheath of small thickness is required, then it may be desirable to allow sufficient clearance between the outer dimensions of the core and the internal dimensions of the sheath before sintering such that, during sintering, the circumferential stresses generated in the sheath as it shrinks onto the core are limited.

In an alternative embodiment the core may be positioned within a suitable mould, and the mould filled with the ceramic material (in powdered or partially-sintered form) to produce the ceramic sheath or sleeve for sintering. The sheath is then sintered such that it shrinks onto the core. In this embodiment, the unsintered sheath is initially in contact with the core but during sintering, as the material of the sheath diffuses, it will shrink into closer contact with the surface of the core.

In any of the aspects of the invention described herein, the ceramic sheaths may be subjected to the pressure before or during sintering.

As described above, embodiments of the invention relate to the formation of sheaths or other structures encircling or surrounding substantially-cylindrical cores. It should be noted, however, that the cores may not be of circular section, but could in principle be of any cross-sectional shape. In addition, if the shape of the core varies from cylindrical, and is for example tapered, the method of the invention is still applicable as long as the substantially-cylindrical core is suited to the formation of a longitudinally-extending structure surrounded by a ceramic sheath.

Similarly, the sheath may not be of circular cross section or of constant cross section along its length but may be of any suitable shape depending on the desired application of the ceramic component.

In further embodiments, the core may be a composite structure, as in the fuel-cell embodiment described below. Similarly, the ceramic sheath may be a composite structure.

As described above, it is important that the sheath shrinks onto the core during sintering; this means that the shrinkage of the sheath must be greater than that of the core. This may be achieved if the core is fully dense, or if it is not fully dense but is of a material or a structure that sinters less than, or more slowly than, that of the sheath during sintering of the sheath. This gives the possibility of the core being, for example, fully dense or partially dense or porous, as required for fabrication of any particular ceramic component.

In a further aspect, the invention provides a ceramic component fabricated using any method embodying the invention.

Embodiments of the invention will now be described by way of example with reference to the accompanying drawings, in which:

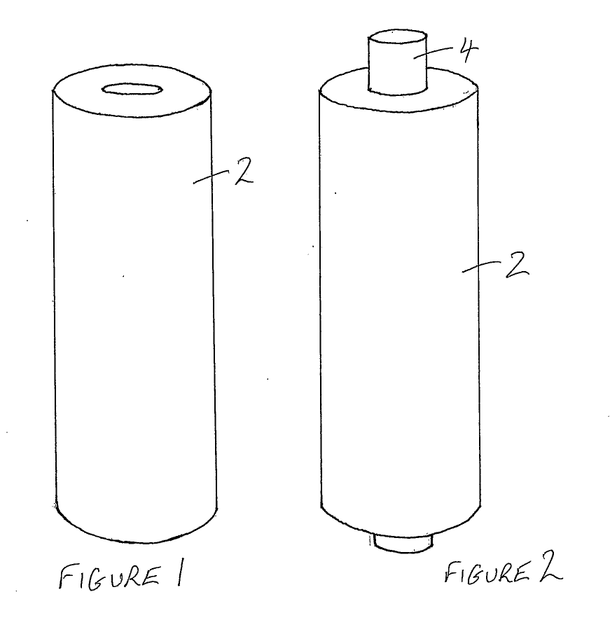

FIG. 1 is a perspective view of an annular SiAION blank for use in a first embodiment of the invention;

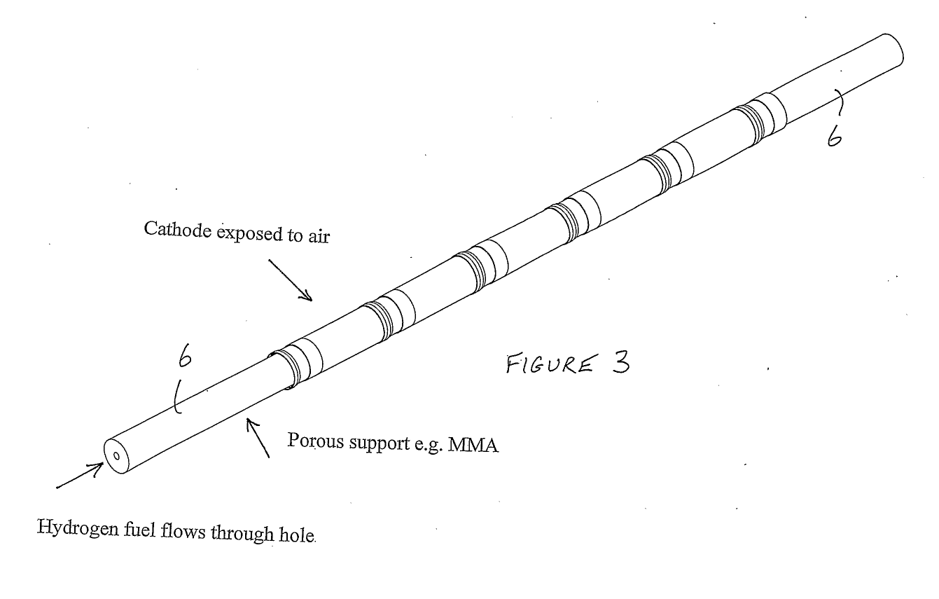

FIG. 2 is a perspective view of a ceramic component formed using the blank of FIG. 1;

FIG. 3 is a perspective view of a fuel cell comprising a MMA core encircled by ZrO₂is sheaths according to a second embodiment of the invention;

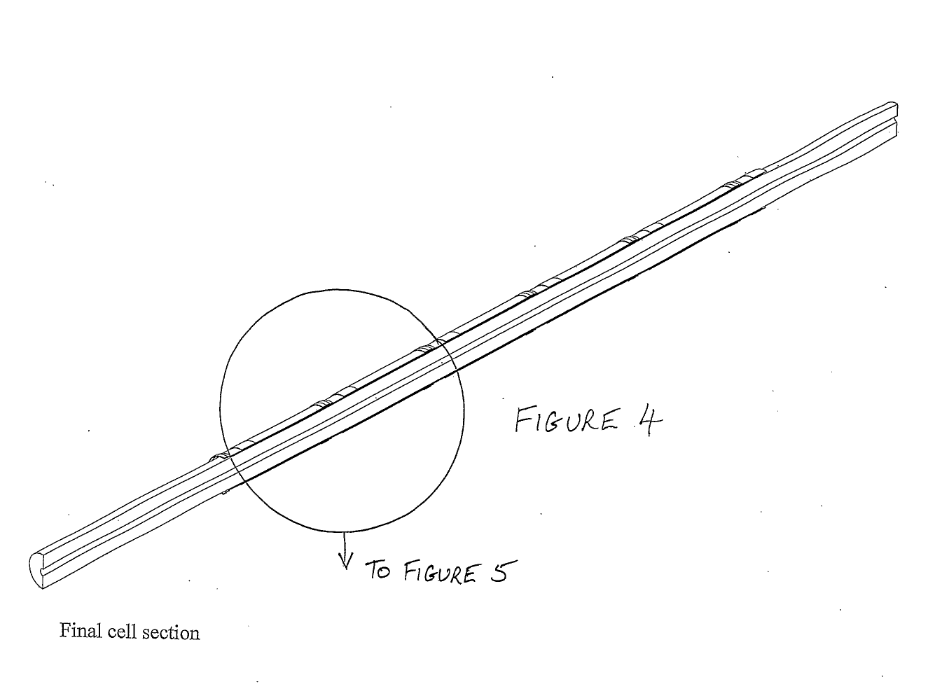

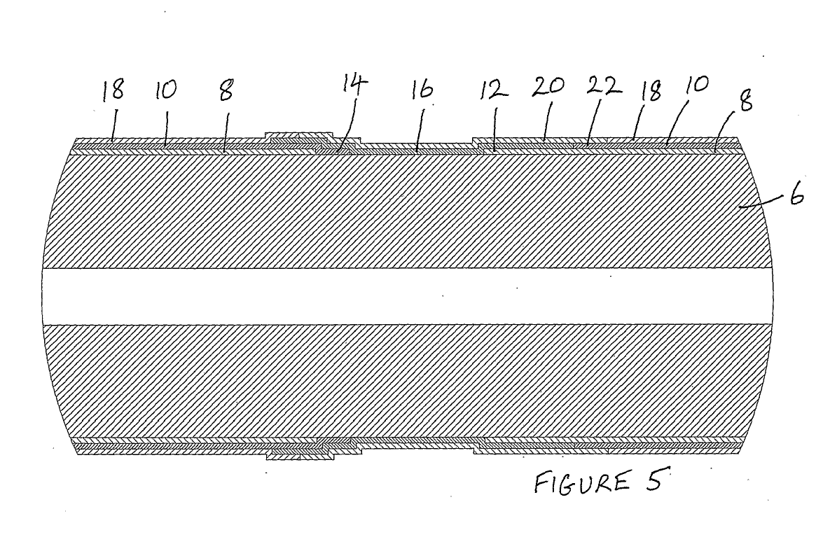

FIG. 4 is a sectional perspective view of the fuel cell of FIG. 3;

FIG. 5 is an enlarged view of a transverse section of the fuel cell of FIG. 3; and

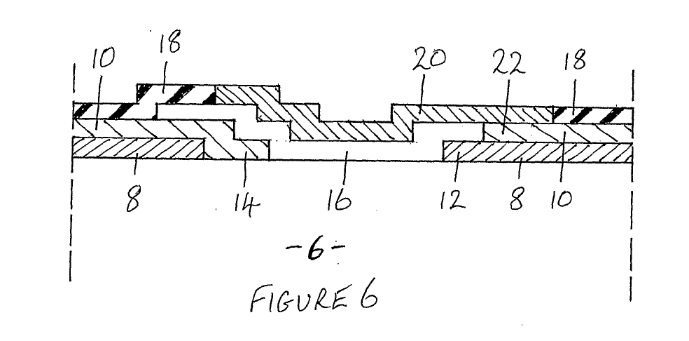

FIG. 6 is a schematic view of the surface layers in FIG. 5.

A first embodiment, illustrated in FIGS. 1 and 2, relates to a hermetically-sealed electrical lead-through consisting of a SiAION insulating sheath of circular section containing a coaxial SiC rod, also of circular section.

In this embodiment, a circular cylindrical SiAION blank is formed by powder fabrication and fired to 1250 C. to achieve partial sintering. The partially-sintered SiAION blank is 50 mm long and of 11.4 mm outside diameter, and is easily machinable; a 1.8 mm diameter hole is drilled along its length to form an annular SiAION blank 2 as illustrated in FIG. 1. A dense, sintered rod 4 of reaction-bonded SiC (also known as REFEL-SiC) 50 mm long and of 1.8 mm outside diameter is then fitted into the drilled hole. It is important that this is a tight fit. The assembly of the SiC rod and the blank is then fired using the normal procedure for sintering SiAION, at 1750 C. This leads to full sintering of the SiAION and causes it to shrink onto the SiC rod, forming a hermetic seal with the rod. After sintering the dimensions of the SiC rod and the internal diameter of the SiAION are unchanged, but the length and outside diameter of the SiAION have reduced to 45 mm and 9.5 mm respectively. It is notable that the presence of the SiC rod slightly constrains the axial shrinkage of the SiAION during sintering; without the SiC rod the SiAION would shrink to a length of 42 mm during the same sintering procedure.

The inventor believes that this procedure works to produce a hermetic seal for the following main reasons.

First, the SiC is dense and so will not shrink during firing at 1750 C. As the SiAION sinters it tends to shrink onto the SiC rod, encouraging a bond to form between the two materials. This may involve a chemical bond or simply a mechanical bond sufficient to cause a hermetic seal, in that there is a tight, or intimate, fit between the surfaces of the two materials.

Second, reaction-bonded SiC contains an appreciable amount of residual silicon as part of the manufacturing process. Silicon melts at about 1400 C. and so, at the sintering temperature of 1750 C. used for SiAION, there may be a liquid phase of Si at the interface between the SiC and the SiAION. The hermetic seal may be formed by the Si liquid completely filling any gaps between the SiC rod and the SiAION. The sealing mechanism may also involve the liquid Si being drawn into pores in the SiAION by capillary action, as the Si melts long before the SiAION densifies.

In general, having a common component or element, such as the Si in this example, between the materials of the core and the sheath may advantageously improve bonding between the core and the sheath.

In this example, the SiC rod is fully dense. It will be noted, however, that the cylindrical core in embodiments of the invention need not be fully dense. Rather, the core should be sufficiently dense or fabricated from a suitable material, such as a material with a sufficiently-high melting point, that during sintering of the ceramic sheath, the core shrinks less than the sheath so that the sheath can shrink onto the core.

In an alternative embodiment, a SiAION sheath may be formed around a SiC core by positioning the core centrally within a cylindrical mould, filling the mould with SiAION in powdered form, and isopressing the SiAION prior to or during sintering at 1750 C. This may advantageously avoid the partial firing and drilling of the SiAION blank described above.

In a further embodiment, illustrated in FIGS. 3, 4 and 5, an embodiment of the invention may be used to manufacture a fuel cell.

The core in the fuel cell embodiment is based on a porous tube 6 of MMA (magnesia/magnesium aluminate), which can be coupled so that hydrogen fuel flows through the tube and diffuses to its surface. A plurality of interconnected fuel cells is then formed along the length of the core as follows.

At regular spacings along the external surface of the MMA tube, electrically-conductive anode layers 8 are applied, encircling the tube. The anode layers may be applied by painting, or by any other suitable method. The final outside diameter of the resulting core is 4.4 mm in the embodiment.

To form an electrolyte layer over each anode layer, annular tubes, or sleeves, of yttrium-stabilised zirconia (YSZ) are formed by extrusion of YSZ powder, mixed with a suitable plasticiser, through an annular die. Lengths of the extruded sleeve 10, of 5.5 mm internal diameter, are slid onto the core, partially covering each length of anode layer 8; the zirconia sleeves are offset from the anode layers such that one end 12 of each anode layer is exposed and the opposite end 14 of each zirconia sleeve overlaps an exposed portion of the MMA tube.

The assembly is then fired using a conventional procedure for sintering extruded YSZ so that each sleeve, or sheath, shrinks onto the core (i.e. onto the anode layer and the MMA tube as appropriate) during sintering. The relative diameters of the core and the sleeves are selected so that the YSZ sleeves shrink onto the anode layer and the tube during sintering. In addition, the thickness of the YSZ sleeves, in combination with their diameter, is selected so as to provide an effective electrolyte in the fuel cell and so as to avoid substantial cracking of the YSZ sleeves during sintering, as they shrink onto the core.

An electrical interconnect layer 16 is then applied, for example by painting or any other suitable method, in the region between each of the YSZ sleeves, so as to make contact with the exposed end 12 of each anode layer. Cathode layers 18 are then applied to the outer surface of each YSZ sleeve, one end of each cathode layer leaving an exposed portion 22 at an end of the underlying YSZ sleeve, and the other end of each cathode layer contacting the adjacent interconnect layer. Thus, each cathode layer is electrically connected, through the intervening interconnect layer, to a neighbouring anode layer along the length of the tube. Finally, a layer of sealing glass 20 is applied to prevent gas diffusion and to cover and protect each interconnect layer and the exposed end 22 of each YSZ electrolyte layer.

The layers other than the YSZ electrolyte layers may be applied in any appropriate manner, including heat-treatment or sintering steps as required. If appropriate, all of the layers may be applied before the YSZ sleeves are sintered, and then the entire assembly sintered in a single firing step.

In use, hydrogen fuel flows through the MMA tube 6 and the cathode layers 18 are exposed to air, for operation of the fuel cell.

We claim:

1. A method for fabricating a ceramic component comprising the steps of:
encircling a core with an unsintered or partially-sintered ceramic sheath; and
sintering the unsintered or partially-sintered sheath such that it shrinks towards or into contact with the core.

2. The method according to claim 1, in which, during the sintering step, the core shrinks less than the sheath.

3. The method according to claim 1, in which the core is substantially cylindrical.

4. The method according to claim 1, in which at least a portion of the core is porous.

5. The method according to claim 1, in which the core is a composite structure.

6. The method according to claim 1, in which the core comprises a sintered ceramic material.

7. The method according to claim 6, in which the core comprises sintered SiC.

8. The method according to claim 6, in which the core comprises sintered MMA.

9. The method according to claim 1, in which the core comprises a metallic material.

10. The method according to claim 1, in which the ceramic sheath is formed by moulding a ceramic powder around the core.

11. The method according to claim 1, in which the ceramic sheath is formed as a green or partially-sintered blank having a surface defining a hole for receiving the core before the blank is sintered.

12. The method according to claim 11, in which the hole is formed by machining or drilling the blank.

13. The method according to claim 1, in which the ceramic sheath is formed by extrusion.

14. The method according to claim 1, in which pressure is applied to the ceramic sheath before sintering.

15. The method according to claim 1, in which the ceramic sheath is sintered under pressure.

16. The method according to claim 1, in which the ceramic sheath comprises SiAION.

17. The method according to claim 1, in which the ceramic sheath comprises YSZ.

18. The method according to claim 1, in which the core is in the shape of a substantially-circular cylinder.

19. The method according to claim 1, in which the core is in the shape of a non-circular cylinder.

20. The method according to claim 1, in which an outer surface of the ceramic sheath is substantially cylindrical, either in the form of a circular cylinder or a non-circular cylinder.

21. The method according to claim 1, in which an outer surface of the ceramic sheath is not cylindrical.

22. A ceramic component fabricated using a method comprising the steps of:
encircling a core with an unsintered or partially-sintered ceramic sheath: and
sintering the unsintered or partially-sintered sheath such that it shrinks towards or into contact with the core.

23. The ceramic component according to claim 22, comprising a core of SiC, encircled by SiAION.

24. The ceramic component according to claim 22, comprising a core of MMA, encircled by YSZ.

25. A method for fabricating a ceramic component substantially as described herein, with reference to the drawings.

26. (canceled)
